(19) United States
(12) Patent Application Publication
(10) Pub. No.: US 2016/0003642 A1
(43) Pub. Date: Jan. 7, 2016

(54) NUMBER WHEELS READ-OUT BASED ON AN INDUCTANCE VALUE

(71) Applicant: TEXAS INSTRUMENTS INCORPORATED, Dallas, TX (US)

(72) Inventors: Tao ZHANG, Chengdu (CN); Ying CHEN, Chengdu (CN)

(21) Appl. No.: 14/531,801

(22) Filed: Nov. 3, 2014

Related U.S. Application Data
(63) Continuation of application No. PCT/CN2014/081456, filed on Jul. 2, 2014.

(51) Int. Cl. G01D 5/20

(52) U.S. Cl. CPC G01D 5/2006

(57) ABSTRACT

An apparatus includes a rotatable element, a coil nearby to the rotatable element, and a conversion unit coupled to the coil. More specifically, the rotatable element is configured to represent a count, wherein the rotatable element includes an outer edge that comprises a plurality of numbers indicating successive increment of a count, and each number is deposited within a conductive layer. The conductive layer associated for the numbers include different sizes. The coil is configured to generate an inductance value for each number based on the size of the conductive layer associated with each number, and the conversion unit is configured to convert the generated inductance value to a digital value.

### CROSS-REFERENCE TO RELATED APPLICATION

This is a continuation of copending International Application No. PCT/CN2014/081456, with an international filing date of Jul. 2, 2014, which designated the United States and is hereby fully incorporated herein by reference for all purposes.

### BACKGROUND

A utility meter is a device that measures the amount of a medium flowing through the meter. The medium may be consumed by a user. Examples of utility meters include electric meters, gas meters, and water meters. A utility meter may need to operate in a harsh environment. To maintain such utility meter such as reading out the medium consumption from the utility meter may require a person to be in proximity to the utility meter, which may make such maintenance a difficult task.

### SUMMARY

Systems and methods to read out a number on a rotatable element by using a conversion unit are disclosed herein. In an embodiment, an apparatus includes a rotatable element, a coil nearby to the rotatable element, and a conversion unit coupled to the coil. More specifically, the rotatable element is configured to represent a count, wherein the rotatable element includes an outer edge that comprises a plurality of numbers indicating successive increment of a count, and each number is deposited within a conductive layer. The conductive layer associated for the numbers include different sizes. The coil is configured to generate an inductance value for each number based on the size of the conductive layer associated with each number, and the conversion unit is configured to convert the generated inductance value to a digital value.

In another embodiment, a system includes a plurality of rotatable elements, a plurality of coils, a conversion unit coupled to the plurality of coils, and a control unit coupled to the conversion unit. More specifically, each rotatable element includes an outer edge that comprises a plurality of numbers indicating successive increment of a count, and each number is deposited within a conductive layer. The conductive layers include different sizes for each number. Each of the plurality of coils is close to one of the rotatable element in a nearby distance so as to generate a distinct inductance value for each number based on the size of the conductive layer associated with such number. The conversion unit is configured to receive each of the generated inductance values, and to convert each of the inductance values to a digital value. The control unit is configured to generate a digital number, based on the digital value, wherein the digital number is associated with the number on the outer edge of the rotatable element.

In a further embodiment, a method includes rotating a rotatable element, wherein the rotatable element includes an outer edge that comprises a plurality of numbers indicating successive increment in a count, and each number is deposited within a conductive layer. The conductive layers include different sizes for each number. The method further comprises generating, by a coil, an inductance value for each number, based on the size of the conductive layer associated with such number; converting, by a conversion unit, the inductance value into a digital value; and generating, by a control unit, a digital number that indicates the number on the outer edge of the rotatable element based on the digital value.

### BRIEF DESCRIPTION OF THE DRAWINGS

For a detailed description of exemplary embodiments of the invention, reference will now be made to the accompanying drawings in which:

FIG. 1 shows a system utilizing an inductance-to-digital (IDC) unit to sense a change of an inductance value in accordance with various embodiments;

FIG. 2 shows an example of a utility meter implementing an inductance-to-digital (IDC) unit to read a change of a number on a number wheel in accordance with various embodiments;

FIG. 3 shows an example of a different size of a conductive layer is deposited on an outer edge for each number of a number wheel in accordance with various embodiments; and

FIG. 4 shows a flow diagram illustrating a method to read a number on a number wheel by using an inductance-to-digital (IDC) unit in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A utility meter is a device that measures the amount of consumption of a particular medium, for example, electricity, gas, water, heat, etc. An electricity meter, for example, measures the amount of electric energy consumed by a residence, business, or an electrically-powered device.

In general, a utility meter preferably include a plurality of number wheels (or counting wheels). Such number wheels are rotatingly actuated. Further, each number wheel is configured to display at least one digital number that corresponds, partially or fully, to a measured amount of the medium. The number wheels of the utility meter generally include different unit values arranged on a drive shaft.

In some cases, the utility meter may be implemented to measure particular usage in a harsh or hazardous environment. Such harsh environments may make reading the meter by a human being difficult or even hazardous. Thus, systems and methods that enable a utility meter to be read without a human being physically near the utility meter is desirable. In this regard, several types of sensors are used in a utility meter to read out the numbers without a human being physically near the utility meter. Such sensors include photoelectric sensors, capacitive proximity sensors, radio frequency identification (RFID) tags, potentiometer encoder, etc. However, the sensors being implemented in the utility meter mentioned herein are subject to several disadvantages, such as high cost for fabrication or assembling, undesirable interference, inaccurate sensing performance and so on.

The embodiments disclosed herein are directed to systems and methods to read out numbers of a utility meter using electromagnetic force to, for example, induce different inductance value for different numbers on the number wheels. More specifically, a distinct value of an inductance for a number on a number wheel of a utility meter is converted by an inductance-to-digital conversion (IDC) unit. The IDC unit may advantageously provide a more accurate way to read the numbers. In a preferred embodiment, the distinct value of the inductance for each number may be implemented by providing a different size of a conductive layer for each of the numbers on the number wheel.

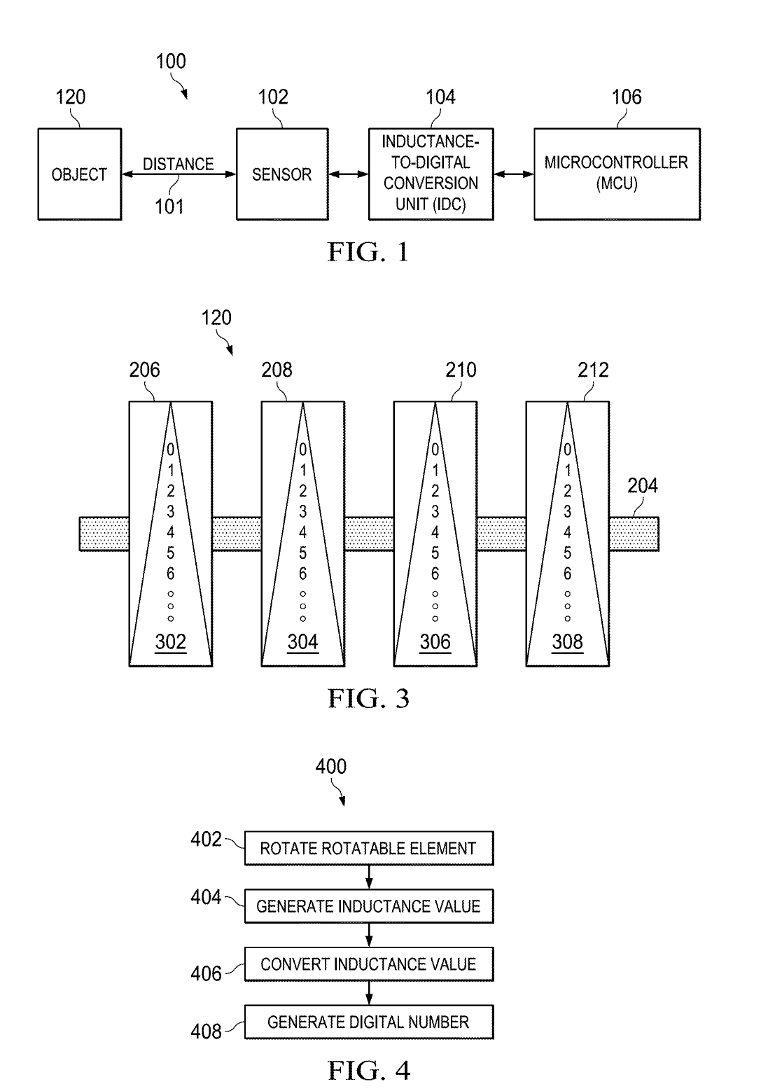

FIG. 1 shows a system 100 using an inductance-to-digital conversion (IDC) unit 104 to be implemented for reading numbers of a utility meter. The system 100 includes an object 120, a sensor 102, the IDC unit 104, and a microcontroller (MCU) 106. In a preferred embodiment, the IDC unit 104 is coupled to the sensor 102 and the MCU 106. The IDC unit 104, the sensor 102 and the MCU 106 may be integrated onto a single printed circuit board (PCB), or they may be separately fabricated. The PCB is a board that mechanically supports and electrically connects electronic components on the board by using conductive traces and/or pads.

In FIG. 1, the sensor 102 is configured to sense an inductance value and provide the sensed inductance value to the IDC unit 104. The object 120 is not coupled to the sensor 102 but is adjacent to the sensor 102 at a close enough distance 101 so as to induce an inductance value on the sensor 102. Generally, the object 120 is made of a conductive material or may be covered with a conductive material so that a change of the distance 101 may provide a change of the induced inductance value.

Multiple objects 120 may be located at the same distance 101 to a sensor 102. Each such object 120 has a conductive material having a shape or size that differs from the conductive material of the other such objects. As such, a different inductance value for each object may be sensed by the sensor 102.

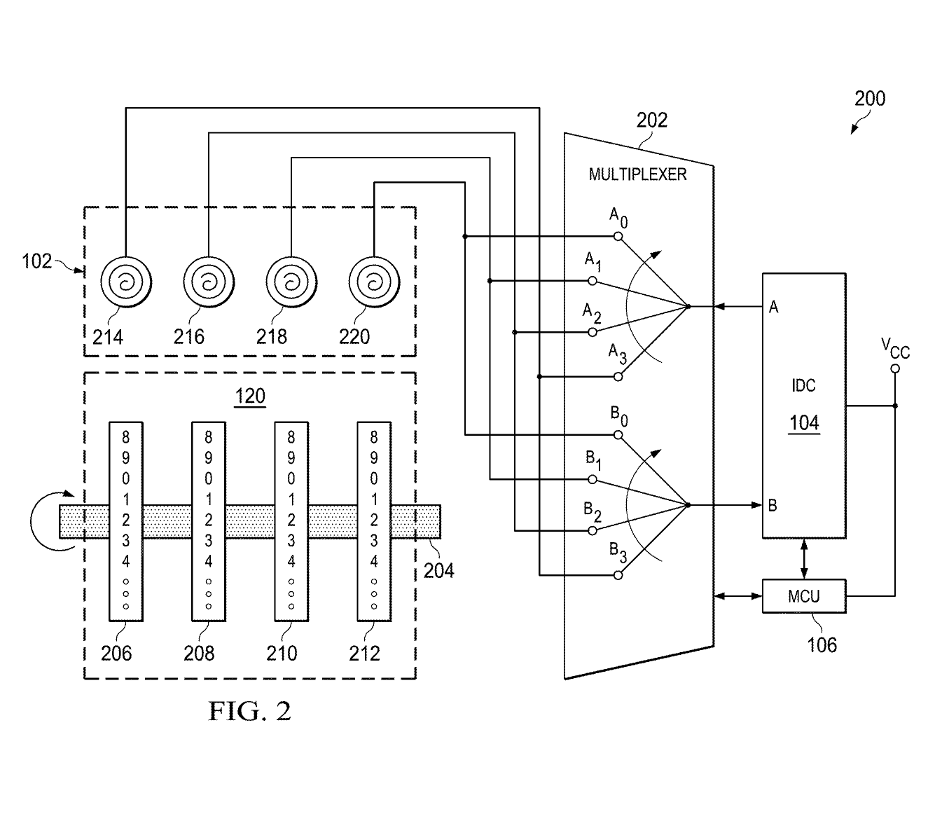

Upon receiving a change of alternating current (AC) associated with the sensed inductance value from the object 120, the IDC unit 104 converts the inductance value to a digital value and provides the digital value to the MCU 106. The MCU 106 receives the digital value from the IDC unit 104 and process the digital value as is suitable for the application. For example, in an alternative application, the IDC unit 104 may be used to monitor a real-time change of the distance 101 between the object 120 (e.g., a tire of a car) and the sensor 102 (e.g., a sensor installed on the car's fender), and the MCU 106 further processes the monitored data to generate an exact number of what the distance is. Details of a mechanism to implement the system 100 in a utility meter will be explained in the block diagram of FIG. 2.

FIG. 2 shows a block diagram to illustrate a further implementation of the system 100 in a utility meter 200. As shown in FIG. 2, the utility meter 200 includes the object 120, the sensor 102, the IDC unit 104 and the MCU 106. Moreover, the utility meter 200 comprises a multiplexer 202 coupled between the sensor 102 and the LDC unit 104 and the MCU 106. Both of the LDC unit 104 and the MCU 106 are powered by a power supply voltage, V_{cc}.

In FIG. 2, the object 120 includes multiple number wheels 206, 208, 210, and 212. In a preferred embodiment, the number wheels are rotated by a driving shaft 204 which extends through a central axis of the number wheels 206, 208, 210, and 212,. Number wheel 206 may represent the highest order number wheel and the number wheel 212 may represent the lowest order. Each number wheel in the example of FIG. 2 includes ten numerals (i.e., 0˜9) and a change of the numerals on the number wheel indicates a successive increment in a count. As such, a read-out of the number wheels from the utility meter 200 may be a four-digit number, and this four digit number may represent consumption of the medium (gas, electricity, etc.) being monitored by the utility meter 200. For example, if the utility meter 200 is used as an electric meter, the utility meter may show “0019”, which means that 19 watts have been consumed and monitored by the utility meter 200. While four number wheels are shown in the example of FIG. 2, in general, any number of wheels may be implemented.

Referring still to FIG. 2, the sensor 102 includes four coils 214, 216, 218, and 220. As shown in FIG. 2, each coil preferably includes an array of spiral conductive loops printed on the PCB. Further, each of the coils is associated with a number wheel (e.g., 206, 208, 210, and 212). For example, coil 214 is associated with number wheel 206. Coils 216, 218 and 220 are associated with number wheels 208, 210 and 212, respectively. In a preferred embodiment, each coil has two ends (or connection points): each of the ends is connected to a node of the multiplexer 202 respectively. More specifically, the coil 220 is coupled to nodes A0 and B0; the coil 218 is coupled to nodes A1 and B1; the coil 216 is coupled to nodes A2 and B2; and the coil 214 is coupled to nodes A3 and B3.

FIG. 3 shows a preferred embodiment of the various number wheels. In this embodiment, a conductive layer (e.g., 302, 304, 306 and 308) is deposited on an outer edge of the number wheel. Each of the numbers on the number wheel is covered by the conductive layer. More specifically, a triangular shape of the conductive layer is used in this example so that each number on the number wheels is distinguishable in terms of size of the conductive layer (e.g., 302, 304, 306 and 308). The size for each number is proportional to a value of such number. For example, as shown in FIG. 3, number “0” is covered by one of the vertices of the triangular shape of the conductive layer, which means that number “0” is covered by the smallest size of the conductive layer. While the number increases, the associated size of the conductive layer increases accordingly. Although a triangular shape of the conductive layer 302 is shown in FIG. 3, any shape for the conductive layer may be used as long as each number is covered by a distinguishable size of the conductive layer. In an alternative embodiment, a distinguishable thickness of the conductive layer may be used for each number of the number wheel. Each number on the number wheel is covered (deposited) with a single type of conductive material, such as aluminum, copper, gold, etc.

The purpose of using the distinguishable size for each number on the number wheel is to induce a different inductance value for each number in accordance with various embodiments. Referring back to the utility meter 200 of FIG. 2, the IDC unit 104 is configured to generate first alternating current (AC current) to one of the coils via a corresponding node (e.g., A0, A1, A2, and A3) to the multiplexer 202. The MCU 106 is configured to control which of the nodes is to be used to transmit the first AC current, generated by the IDC unit 104, to the coil. For example, if the MCU 106 is to read the lowest order number wheel (i.e., 212), the MCU 106 may cause the multiplexer 202 to switch to the nodes A0 and B0. Thus, the first AC current is transmitted through the node A0 to the corresponding coil 220 and a change in AC current (discussed below) is received by the IDC unit 104 via the node B0. Upon the first AC current being received by the coil 220, the coil 220 generates an alternating magnetic field. The alternating magnetic field induces an eddy current on a surface of the conductive layer of the corresponding number wheel 212. In a preferred embodiment, the circulating eddies of current have inductance and thus induce an opposing magnetic field. Since each number on the outer edge of the number wheel is covered by a distinguishable size of the conductive layer, a different inductance value for each number resulting from the circulating eddies of current induced on the corresponding coil.

Referring still to the example of FIG. 2, this opposing magnetic field induced by the eddy current, in turn, causes a change in the amount of the original AC current in the coil 220. The changed AC current resulting from the eddy current transmits back to the IDC unit 104 via the node B0. The IDC unit 104 converts the change of the AC current into a digital value. Based on the digital value provided by the IDC unit 104, in a preferred embodiment, the MCU 106 may search for a look-up table to find a corresponding digital number, wherein the digital number is associated with the number on the number wheel.

As such, the disclosed embodiments enables the utility meter 200 to read out the number without an electromagnetic interference since each number is covered by a different, and distinguishable, size of the conductive layer (e.g., 302) which, in turn, leads to a different inductance value. Based on the different inductance value, the IDC unit 104 is able to generate a different digital value for each number on the number wheel. Furthermore, providing multiple number wheels (e.g., 4 number wheels as shown in FIG. 2), the MCU 106 may be able to read multiple combination of digital numbers associated with the numbers on the number wheels and transmit a value that encodes the numbers on the wheels as desired to an external system.

FIG. 4 shows a flow diagram 400 to illustrate a method manipulating the disclosed utility meter 200 in accordance with various embodiments. The diagram 400 starts with block 402 to rotate a rotatable element, such as the number wheel (e.g., 206, 208, 210, and 212). In a preferred embodiment, for the utility meter 200, the rotation of the rotatable element is actuated, by a change of the utility consumption being monitored by the utility meter 200.

The diagram 400 continues with block 404 to generate an inductance value. Each time the rotatable element is rotated, the number on the outer edge of the rotatable element is preferably to change to a next decimal digit. For example, if a number shown on a rotatable element is currently shown as numeral “2”, the rotation of the rotatable element causes the number shown on the rotatable element to change from “2” to “3”. As described above, each of the number possesses a different size of the conductive layer, which results in a change of an inductance value. Then the changed inductance value preferably causes a changed AC current which is sensed by the IDC unit 104. The diagram 400 continues with block 406 to convert the changed AC current by the IDC unit 104. In a preferred embodiment, the IDC unit 104 is configured to convert the changed AC current to a digital value.

Still referring to FIG. 4, after the digital value has been converted by the IDC unit 104, at block 408, the MCU 106 is preferably to generate a digital number based on the digital value. The digital number is associated with the number on the rotatable element which is just being shown due to the rotation.

The system 100 may be fabricated using conventional complementary metal oxide semiconductor (CMOS) process, such as metal deposition, photolithography, etc. Additionally or alternately, in a preferred embodiment, the system 100 may be fabricated using a three-dimensional (3D)-printing method. A 3D printing method is any of various processes of making a 3D object from a 3D model through additive process in which successive layers of material are deposited or laid down under a computer control. More specifically, each component (the number wheel 120, the sensor 102, the IDC unit 104 and the MCU 106) of the system 100 may be integrated as a 3D model and based on the 3D model, the system 100 can be fabricated using the 3D printing method.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An apparatus, comprising:
a rotatable element configured to represent a count, wherein the rotatable element includes an outer edge that comprises a plurality of numbers indicating successive increment of a count, and each number is deposited within a conductive layer, the conductive layer being of different sizes for each number;
a coil nearby to the rotatable element to generate an inductance value for each number based on the size of the conductive layer associated with each number; and
a conversion unit coupled to the coil to convert the generated inductance value to a digital value.

2. The apparatus of claim 1, further comprising a control unit coupled to the conversion unit and configured to generate a digital number based on the digital value.

3. The apparatus of claim 1, wherein the size of the conductive layer for each number is proportional to the number associated with that layer.

4. The apparatus of claim 1, wherein the conductive layer is of different shapes for each number on the rotatable element.

5. The apparatus of claim 1, further comprising a plurality of coils and a plurality of rotatable elements, each coil corresponding to different rotatable element and configured to generate an inductance value specific to the corresponding rotatable element.

6. The apparatus of claim 5, wherein the coils are on a printed circuit board.

7. The apparatus of claim 1, wherein the digital value is generated by the conversion unit based on a change between two values of alternating current.

8. The apparatus of claim 1, wherein the digital number is an integer that indicates a corresponding number on the outer edge of the rotatable element.

9. The apparatus of claim 1, wherein the apparatus is a utility meter.

10. A system, comprising:
a plurality of rotatable elements, each rotatable element includes an outer edge that comprises a plurality of numbers indicating successive increment of a count, and each number is deposited within a conductive layer, the conductive layer being of different sizes for each number;
a plurality of coils, each coil is close to one of the rotatable element in a nearby distance so as to generate a distinct inductance value for each number based on the size of the conductive layer associated with such number;
a conversion unit coupled to the plurality of coils to receive each of the generated inductance values, and to convert each of the inductance values to a digital value; and
a control unit coupled to the conversion unit to generate a digital number, based on the digital value, wherein the digital number is associated with the number on the outer edge of the rotatable element.

11. The system of claim 10, wherein the size of each conductive layer is proportional to the number associated with that layer.

12. The system of claim 10, wherein the coil includes an array of spiral conductive loops printed on a printed circuit board.

13. The system of claim 10, wherein the conversion unit is configured to convert each of the inductance values into the digital values based on a change between two values of alternative current.

14. The system of claim 10, wherein the system is a utility meter.

15. A method, comprising:
rotating a rotatable element, wherein the rotatable element includes an outer edge that comprises a plurality of numbers indicating successive increment of a count, and each number is deposited within a conductive layer, the conductive layer being of different sizes for each number;
generating, by a coil, an inductance value for each number, based on the size of the conductive layer associated with such number;
converting, by a conversion unit, the inductance value into a digital value; and
generating, by a control unit, a digital number that indicates the number on the outer edge of the rotatable element based on the digital value.

16. The method of claim 15, wherein the digital value is based on a change between two values of alternative current.

17. The method of claim 15, wherein the different sizes include different thickness for each of the conductive layers.
